(19) United States
(12) Patent Application Publication
(10) Pub. No.: US 2006/0041882 A1
(43) Pub. Date: Feb. 23, 2006

(54) Replication of firmware

(76) Inventor: Mehul Shah, Austin, TX (US)

Correspondence Address: LIEBERMAN & BRANDSDORFER, LLC, 802 STILL CREEK LANE, GAITHERSBURG, MD, 20878, US

(21) Appl. No.: 10/924,184

(22) Filed: Aug. 23, 2004

(51) Int. Cl. G06F 9/44

(52) U.S. Cl. 717/171; 717/176

(57) ABSTRACT

A system and method for replicating firmware in each node of a multi-node computer system is provided. When a joining node becomes a member of the system, the firmware of the joining node is replicated and stored in local memory of the joining node. The portion of local memory where the firmware resides is designated as private memory to the joining node. When a calling processor on a node in the system requires access to firmware, the controller on the node will decide its memory request destination. Since the firmware is located in the private memory of each node, the requesting node will be assigned a memory address in its private memory.

### BACKGROUND OF THE INVENTION

1. Technical Field

This invention relates to improving operating system performance. More specifically, the invention relates to localizing firmware access for each node of a multi-node system.

2. Description Of The Prior Art

Multiprocessor systems by definition contain multiple processors, also referred to herein as CPUs, that can execute multiple processes or multiple threads within a single process simultaneously, in a manner known as parallel computing. In general, multiprocessor systems execute multiple processes or threads faster than conventional uniprocessor systems that can execute programs sequentially. The actual performance advantage is a function of a number of factors, including the degree to which parts of a multithreaded process and/or multiple distinct processes can be executed in parallel and the architecture of the particular multiprocessor system at hand. The degree to which processes can be executed in parallel depends, in part, on the extent to which they compete for exclusive access to shared memory resources.

The architecture of shared memory multiprocessor systems may be classified by how their memory is physically organized. In distributed shared memory (DSM) machines, the memory is divided into modules physically placed near one or more processors, typically on a processor node. Although all of the memory modules are globally accessible, a processor can access local memory on its node faster than remote memory on other nodes. Because the memory access time differs based on memory location, such systems are also called non-uniform memory access (NUMA) machines. On the other hand, in centralized shared memory machines, the memory is physically in one location. Centralized shared memory computers are also called uniform memory access (UMA) machines because the memory is equidistant in time for each of the processors. Both forms of memory organization typically use high-speed caches in conjunction with main memory to reduce execution time.

The use of NUMA architecture to increase performance is not restricted to NUMA machines. A subset of processors in an UMA machine may share a cache. In such an arrangement, even though the memory is equidistant from all processors, data can circulate among the cache-sharing processors faster, i.e. with lower latency, than among the other processors in the machine. Algorithms that enhance the performance of NUMA machines can thus be applied to any multiprocessor system that has a subset of processors with lower latencies. These include not only the noted NUMA and shared-cache machines, but also machines where multiple processors share a set of bus-interface logic as well as machines with interconnects that “fan out” (typically in hierarchical fashion) to the processors.

Modem computer systems typically have firmware stored in non-volatile memory. Non-volatile memory is a category of memory that holds their content without electrical power and includes read-only memory (ROM), programmable ROM (PROM), erasable and programmable ROM (EPROM), electrically erasable and programmable ROM (EEPROM), and flash memory technologies. The firmware may include the Basic Input/Output System (BIOS) of the computer system. The BIOS is a set of routines in a computer which provides an interface between the operating system and the hardware, also known as boot and run time services. Typically, the BIOS supports all peripheral technologies and internal services.

When a multiprocessor computer system is first powered on or otherwise reset, the processors in the system are initialized by setting them to a known state. The power on process or reset causes a processor to jump to the system BIOS to begin code execution. The BIOS brings the system through an initialization procedure (also called booting) whereby diagnostic routines are run on the system hardware, such as memory and the processors. In prior art multiprocessor systems, as each node joins the system, the BIOS of each joining node is removed from that node. The only BIOS remaining in the formed multi-node system is that of the node that is responsible for the initialization procedure of the multi-node system. However, there are drawbacks associated with removing the BIOS of the individual nodes joining the system. For example, all processors in the multi-node system execute run time services, e.g. BIOS Interrupt Services, System Management Services, EFI Services, etc. When there is only one BIOS remaining in the system, execution of run time services are from the same shared memory. This shared memory is local to processors of a node that is responsible for booting the operating system, but it is remote to all processors of other nodes in the multi-node system. Accordingly, more time is required for a processor to execute a run time service if the shared memory housing the BIOS is physically located on a remote node than if the BIOS is physically located in local memory.

There is therefore a need for improving operating efficiency for execution of run time services for a multi-node computer system. The novel BIOS replication solution presented herein promotes improved operating efficiency for execution of run time service by preserving the locality of the BIOS for each processor in a multi-node system.

### SUMMARY OF THE INVENTION

This invention comprises a method and system for localizing firmware access for each node of a multi-node system.

In one aspect of the invention, a method is provided for improving operating system performance. Firmware of a node joining a multi-node system is replicated in local memory as private memory of the joining node. In response to an operating system call, the firmware is accessed in the local memory of the node.

In another aspect of the invention, a computer system is provided with a firmware manager adapted to replicate firmware of a node joining a multi-node system in local memory as private memory of the joining node. A memory manager is provided to access the firmware in the local memory of the node in response to an operating system call.

In yet another aspect of the invention, an article is provided in a computer-readable signal-bearing medium. Means in the medium are provided for replicating firmware of a node joining a multi-node system in local memory as private memory of the joining node. In addition, means in the medium are provided for accessing the firmware in the local memory of the node in response to an operating system call

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art multiprocessor computer system.

FIG. 2 is a block diagram of a single node in the multiprocessor computer system of FIG. 1.

FIG. 3 is block diagram of a prior art memory distribution of a multi-node computer system.

FIG. 4 is a flow chart of the firmware replication and designation process according to the preferred embodiment of this invention, and is suggested for printing on the first page of the issued patent.

FIG. 5 is a block diagram of memory distribution of a multi-node computer system.

### DESCRIPTION OF THE PREFERRED EMBODIMENT

### Overview

A method and system for improving operating system performance in a multi-node computer system are described herein. Each node in a multi-node system has firmware. Prior to joining the multi-node system, each node has its own BIOS located on its ROM. During the process of joining the multi-node system, the firmware of the joining node is replicated and stored on local memory of the joining node. The memory location of the firmware is designated as private memory. At such time as any node in the system requires access to firmware for execution of run time services, the respective node accesses the firmware in the private address space of the requesting node's local memory.

### Technical Details

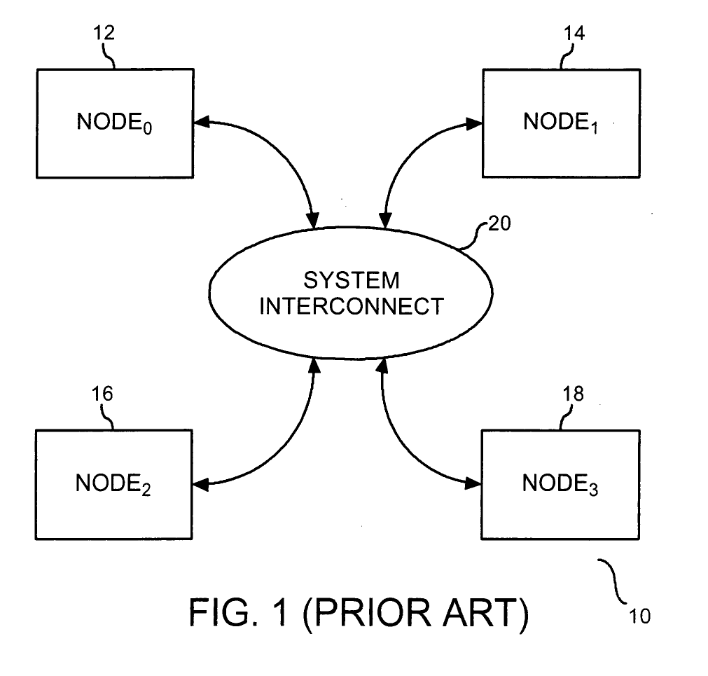

As illustrated in FIG. 1, a multiprocessor system (10) includes multiple nodes. The system (10) is a Distributed Shared Memory (DSM) architecture, which may or may not be a Non-Uniform Memory Access machine (NUMA). As shown in FIG. 1, there are four nodes, Node₀ (12), Node₁ (14), Node₂ (16), and Node₃ (18), that are each connected by a system interconnect (20) that permits any node to communicate with any other node in the system. Although four nodes are shown in FIG. 1, system 10 could include more or less than four nodes. The purpose of the system interconnect (20) is to allow processors in any node to access the memory resident in any other node in the system. The physical links of system interconnect (20) provide high bandwidth and low latency and are scalable to allow for the addition of more nodes in the system (10). Accordingly, the multiprocessor system (10) is an illustration of the connection of each of the nodes for allowing shared memory access.

A node constructed with four processors is referred to as a quad. Each of the nodes, Node₀ (12), Node₁ (14), Node₂ (16), and Node₃ (18), may be referred to as home nodes or remote nodes. A home node is a node in which the address of the memory block falls within the address range supported by the local memory or cache, and a remote node is a node in which the memory block is not within the address range supported by local memory or cache. In addition, a node may be a requesting node or a responding node. A requesting node is a node requesting data, and responding node is a node providing data. Accordingly, each node in the system includes memory which may be locally or remotely accessed by each other node in the system.

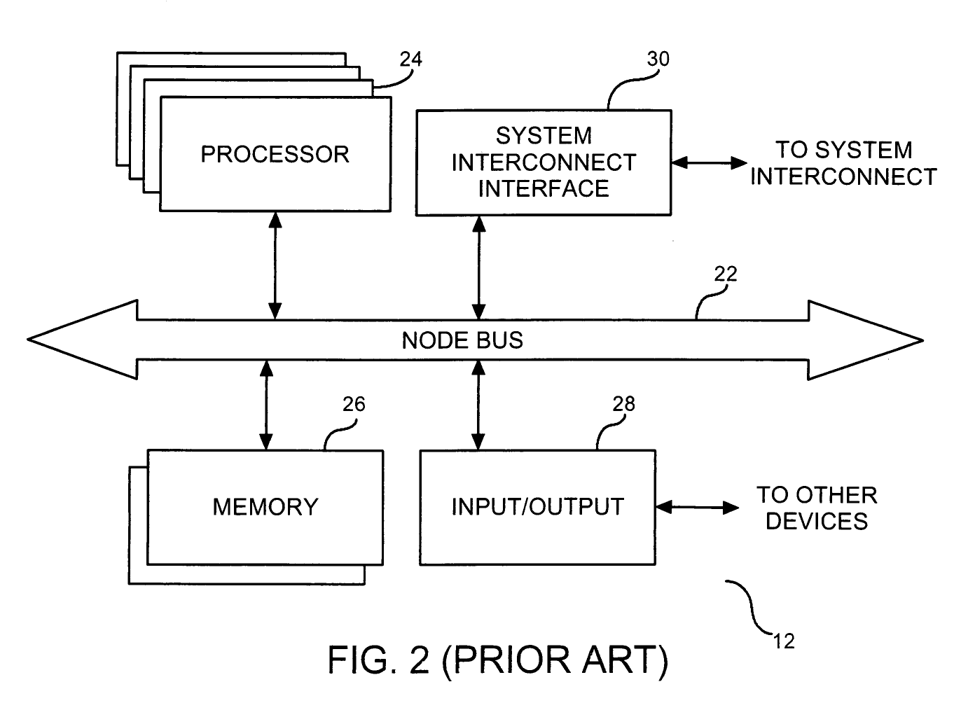

FIG. 2 is a block diagram of Node₀ (12) on system (10). Node₀ (12) includes a conventional symmetrical multiprocessor (SMP) node bus (22) for connecting multiple data processors (24) to local memory (26). In addition, node bus (22) connects a system interconnect interface (30) to local input/output (28). The system interconnect interface (30) also connects to the system interconnect. Similarly, the I/O (28) connects to other I/O devices in the system.

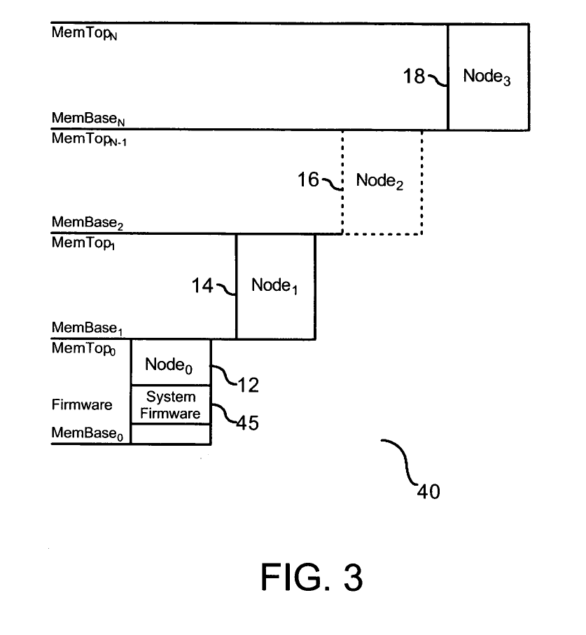

FIG. 3 is a block diagram (40) of prior art memory distribution of the multi-node system (10) showing the four nodes Node₀ (12), Node₁ (14), Node₂ (16), and Node₃ (18) and system memory allocation. All of the memory in each of the nodes is shared memory, i.e. memory that is accessible by any of the nodes in the system. The system firmware (45), which includes the BIOS, is local to Node₀ (12). The remaining nodes Node₁ (14), Node₂ (16), and Node₃ (18) all have an equal quantity of memory local to the respective node, with all of the memory in each of the remaining nodes being shared memory, i.e. available to any node in the system (10). Based upon the memory distribution shown herein, the system firmware (45) is only local to Node₀ (12). Any node in the system other than Node₀ (12), that requires use of the firmware must make a request to access non-local memory. For example, if Node₂ (16) needs to access the system firmware (45) it must make a memory request to access the system firmware (45) on Node₀ (12). Since the firmware is not local to Node₂ (16), the firmware request is a remote access. Therefore, there is an increased time for the remote memory access from Node₂ (16), as compared to a local memory request. In fact, all nodes accessing the system firmware (45), aside from Node₀ (12), require a remote access to this area of the shared memory.

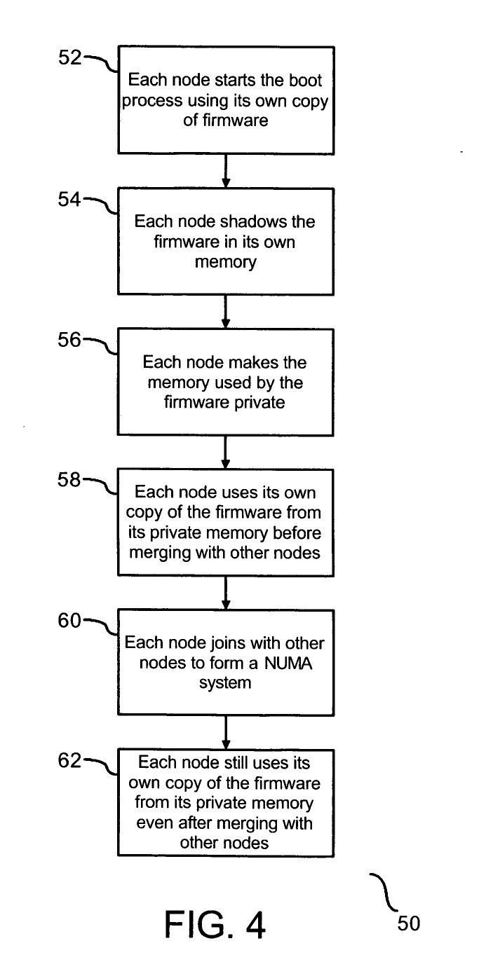

In order to mitigate the increased time with remote memory accesses to the system firmware, each node in a multi-node system retains a copy of their own BIOS in local memory designated as private memory for the respective node. Private memory is only accessible to a node owning the private memory. FIG. 4 is a flow chart (50) illustrating the process utilized to support local access to system firmware in a multi-node computer system for each individual node. As shown, each node in the multi-node system starts the boot process for their respective node using its own firmware (52), which could be stored on a ROM chip of the booting node. The local copy of the BIOS could also be stored in a shadow RAM. Shadowing is a technique used to increase a computer's speed by using high-speed RAM in place of slower ROM. The RAM is called shadow RAM. Following step (52), each node shadows its firmware in its own memory (54), i.e. local memory, and designates the memory shadowed into RAM private memory (56). Thereafter, each node in the system can use its own copy of the firmware from its private memory before merging with other nodes in the system (58). During the process of merging the joining node to the multi-node system, a review is conducted to ensure that the firmware being retained in the joining node is identical or at least compatible with the firmware of the base node of the system, i.e. Node₀ (12). Following the process of merging the joining node into the system (60), each node replicates its firmware and retains a copy of the replicated firmware in its private memory (62). The replicated firmware is the firmware of the node joining the system. Each node can have different, but similar firmware. If the firmware of a joining node is not identical to the firmware of the base node, i.e. Node₀ (12), the joining node and the base node must have an identical interface for inter-node communication to enable the nodes to be merged into a single computing system. The process of retaining a copy of the firmware in the private memory of each node in the system enables all firmware access requests to be local memory requests. For example, if a run time service is called by a processor on Node₁ (14), the memory controller on Node₁ (14) decides its destination. If the address belongs to the private address space, it will always be passed on to the private memory on the same node. Therefore, the run time service called by a processor on Node₁ (14) accesses the firmware on Node₁ (14). An identical memory address is used in each node to store the replicated firmware. The same address is decoded by each node as their private memory address for the firmware. Since every node owns the same address space for the firmware, only the processor on the same node can access it. Accordingly, the copy of the firmware to be used to support the run time service is implicitly decided based upon the node where the calling processor is residing.

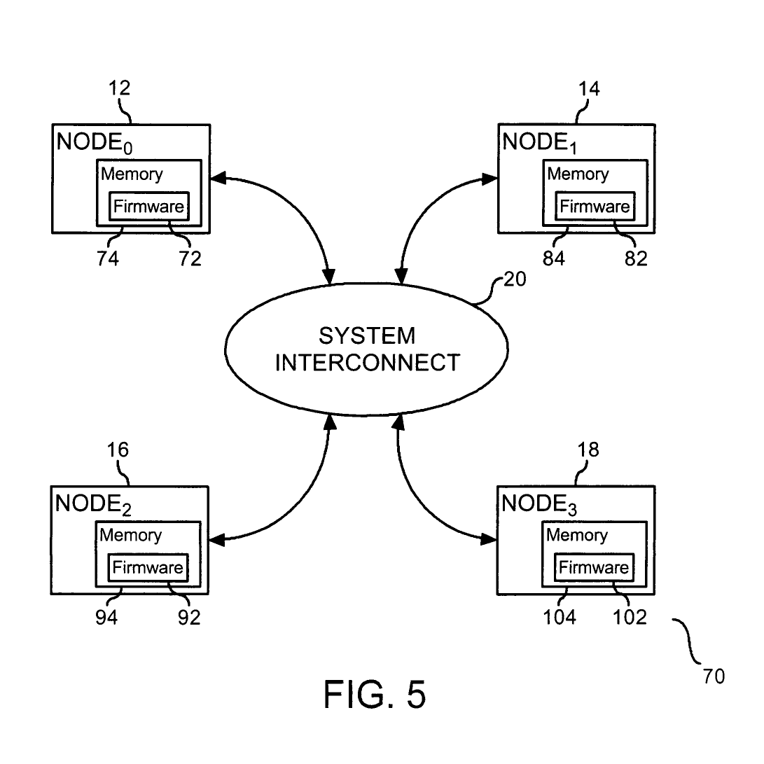

FIG. 5 is a block diagram (70) of memory distribution of the multi-node system (10) showing Node₀ (12), Node₁ (14), Node₂ (16), and Node₃ (18) and system memory allocation with firmware replication. Each node in the system has shared memory, i.e. memory that is accessible by any node in the system, and private memory, i.e. memory that is reserved for that node. Each node has their own firmware, which includes BIOS, stored in private memory of the respective node. As shown, Node₀ (12) has firmware in a private memory block (72) with the remaining memory (74) designated as shared memory. Each node's private memory block has an identical address with identical or compatible system firmware. For example, Node₁ (14) has its firmware in its private memory block (82) with the same address space as the firmware (72) of Node₀ (12) and the remaining memory (84) designated as shared memory, Node₂ (16) has its firmware in its private memory block (92) with the same address space as the firmware (72) of Node₀ (12) and the remaining memory (94) designated as shared memory, and Node₃ (18) has its firmware in its private memory block (102) with the same address space as the firmware (72) of Node₀ (12) and the remaining memory (104) designated as shared memory. Although the firmware of each node is stored in a memory area that has the same memory address space as the memory space in which the firmware of other node is stored, the allocation of all shared memory is sequential. For example, in one embodiment, each node is provided sixty four gigabytes of memory, with sixteen megabytes reserved for firmware. As such, the memory (74) of Node₀ (12) includes a block of the first 64 gigabytes less 16 megabytes reserved as private memory for firmware (72), the memory (84) of Node₁ (14) extends from 64 gigabytes to 128 gigabytes less 16 megabytes reserved as private memory for firmware (82), the memory (94) of Node₂ (16) extends from 128 gigabytes to 192 gigabytes less 16 megabytes reserved as private memory for firmware (92), and the memory (104) of Node₃ (18) extends from 192 gigabytes to 256 gigabytes less 16 megabytes reserved as private memory for firmware (102). With the exception of the private memory designated in each node, the memory of each of the other nodes in the system is shared memory. Each nodes private memory block has an identical address with identical or compatible system firmware. The designation of the firmware of each node as private memory enables the memory controller of each node to respond to the same address space. Accordingly, the operating system can use the same address to call run time services from any processor in the multi-node system.

### Advantages Over The Prior Art

The replication of system firmware in private memory of each node in a multi-node system mitigates remote memory requests for run time services. The replicated firmware is compatible, if not identical, to the firmware in the base node of the multi-node system. When any node in the system requires access to system firmware, the memory request is always local. In accordance with the present invention, remote memory requests for firmware access are eliminated, thus reducing time associated with a remote memory request.

### Alternative Embodiments

It will be appreciated that, although specific embodiments of the invention have been described herein for purposes of illustration, various modifications may be made without departing from the spirit and scope of the invention. In particular, the firmware replication process and designation as private memory may be used in other multi-node computer systems in addition to a NUMA system. Additionally, the same method can be used to replicate diagnostic software tools to enable the testing of the system interconnect since there is no traffic on the system interconnect while using private memory. Accordingly, the scope of protection of this invention is limited only by the following claims and their equivalents.

We claim:

1. A method for improving operating system performance comprising:
(a) replicating firmware of a node joining a multi-node system in local memory as private memory of said joining node; and
(b) accessing said firmware in said local memory of said node in response to an operating system call.

2. The method of claim 1, wherein the step of replicating firmware in a node joining a multi-node system includes ensuring compatibility of said replicated firmware with said multi-node system.

3. The method of claim 1, wherein said private memory is only accessible to a node owning said private memory.

4. The method of claim 1, wherein the step of replicating firmware in each node in a multi-node system occurs following a merge of said node into said system.

5. The method of claim 1, further comprising storing said replicated firmware in an identical memory address in each node.

6. The method of claim 5, wherein the step of storing said replicated firmware in an identical memory address in each node supports an operating system using said address from any processor in said system.

7. A computer system comprising:
a firmware manager adapted to replicate firmware of a node joining a multi-node system in local memory as private memory of said joining node; and
a memory manager adapted to access said firmware in said local memory of said node in response to an operating system call.

8. The system of claim 7, wherein said firmware manager ensures compatibility of said replicated firmware with said multi-node system.

9. The system of claim 7, wherein said private memory is only accessible to a node owning said private memory.

10. The system of claim 7, wherein said firmware manager replicates said firmware of a joining node subsequent to a merge of said node into said system.

11. The system of claim 7, wherein said memory manager is adapted to store said replicated firmware in an identical memory address in each node.

12. The system of claim 11, wherein storage of said replicated firmware in an identical memory address in each node supports an operating system use of said address from any processor in said system.

13. An article comprising:
a computer-readable signal-bearing medium;
means in the medium for replicating firmware of a node joining a multi-node system in local memory as private memory of said joining node; and
means in the medium for accessing said firmware in said local memory of said node in response to an operating system call.

14. The article of claim 13, wherein said medium is selected from a group consisting of: a recordable data storage medium, and a modulated carrier signal.

15. The article of claim 13, wherein said means for replicating firmware of a node joining a multi-node system ensures compatibility of said replicated firmware with said multi-node system.

16. The article of claim 17, wherein said private memory is only accessible to a node owning said private memory.

17. The article of claim 7, wherein said means for replicating firmware of a node joining a multi-node system replicates said firmware of a joining node subsequent to a merge of said node into said system.

18. The article of claim 13, wherein said means in the medium for designating said replicated firmware as private memory of said joining node is adapted to store said replicated firmware in an identical memory address in each node.

19. The system of claim 18, wherein storage of said replicated firmware in an identical memory address in each node supports an operating system use of said address from any processor in said system.

20. A method for improving operating system performance comprising:
replicating firmware of a node joining a multi-node system in local memory; and
designating said replicated firmware as private memory of said joining node.
